(19) United States
(12) Patent Application Publication
(10) Pub. No.: US 2024/0328019 A1
(43) Pub. Date: Oct. 3, 2024

(54) GAS BLOCK FOR THE REMOVAL OF MULTIPLE CONTAMINANTS FROM A GASEOUS STREAM FROM AN ELECTROLYSER

(71) Applicant: Enapter S.R.L., Crespina Lorenzana (IT)

(72) Inventors: Ralph CALDECOTT, Crespina Lorenzana (IT); Sean Crawford CHAPMAN, Crespina Lorenzana (IT); Vito PINTO, Crespina Lorenzana (IT); Lazarus DIAMOND, Crespina Lorenzana (IT); Michael SOEHNER, Crespina Lorenzana (IT); Thorben BUSCH, Crespina Lorenzana (IT)

(21) Appl. No.: 18/577,695

(22) PCT Filed: Jul. 8, 2022
(86) PCT No.: PCT/EP2022/069195

§ 371 Date: Jan. 8, 2024

(30) Foreign Application Priority Data
Jul. 9, 2021 (GB) 2109977.5

(51) Int. Cl. C25B 15/08; B01D 46/00; B01D 53/04; B01D 53/26

(52) U.S. Cl. CPC C25B 15/085; B01D 46/0031; B01D 53/04; B01D 53/265; B01D 53/266; B01D 2253/206; B01D 2256/16; B01D 2257/40; B01D 2257/80

(57) ABSTRACT

A gas block (10) for the removal of multiple contaminants from a gaseous stream from an electrolyser (1). The gas block (10) comprises at least one inlet (13), the at least one inlet being configured to receive a gaseous stream from an electrolyser, and at least two outlets (12, 14), wherein the first outlet (12) is configured for the removal of contaminant liquid from the gas block, and the second outlet (14) is configured for the release of the gaseous stream from the gas block. A first removal chamber (15) is situated along a flow path of the gaseous stream between the at least one inlet and the first outlet, the first removal chamber being for removal of liquid and/or vapour from the gaseous stream. A second removal chamber (16) is situated along a flow path of the gaseous stream between the first removal chamber and the second outlet, the second removal chamber being for removal of a further contaminant from the gaseous stream. The gas block is primarily for use in the purification of a hydrogen stream from an electrolyser.

### FIELD OF INVENTION

The present invention relates to an improved gas block for processing a gaseous stream from an electrolyser, for example a gaseous stream of hydrogen.

### BACKGROUND

Hydrogen has a multitude of applications, ranging from energy storage to the production of fertilisers. Hydrogen can be derived from many sources. Some of these sources, such as fossil fuels, are undesirable for obvious reasons. Therefore, there is a need to be able to produce hydrogen in a reliable and sustainable manner.

Electrolysers are devices used for the generation of hydrogen and oxygen by splitting water. It is possible to power such devices with excess renewable energy, using hydrogen as a means for energy storage as opposed to batteries, for example. Electrolysers generally fall in one of three main technologies currently available, namely anion exchange membrane (AEM), proton exchange membrane (PEM), and liquid alkaline systems. Liquid alkaline systems are the most established technology, with PEM being somewhat established. AEM electrolysers are a relatively new technology. Other technologies, such as solid oxide electrolysis, are available.

AEM and PEM electrolysers are reliant on the transfer of ions from one half-cell to the other for the generation of hydrogen. AEM systems rely on the movement of hydroxide ions, OH—, whilst PEM systems rely on the movement of hydrogen ions, H+.

Whilst certain forms of electrolysis allow for the production of relatively pure Hydrogen, such as AEM electrolysis with a dry cathode, it is sometimes necessary to further process the hydrogen to purify it prior to compression, use or storage.

At present such means for purification are separate units for different contaminants, such as a dryer for the removal of water, and other devices for the removal of other potential contaminants such as amines from degrading membranes, or other products resulting from degradation of upstream components.

The object of the present invention is to provide an improved combined means for the removal of multiple contaminants from a gaseous stream containing predominantly hydrogen.

### SUMMARY OF THE INVENTION

Aspects and embodiments of the present invention are set out in the appended claims. These and other aspects and embodiments of the invention are also described herein.

According to at least one aspect described herein, there is provided a gas block for the removal of multiple contaminants from a gaseous stream from an electrolyser, comprising: at least one inlet, the at least one inlet being configured to receive a gaseous stream from an electrolyser; and at least two outlets, wherein the first outlet is configured for the removal of liquid from the gas block, and the second outlet is configured for the release of the gaseous stream from the gas block, wherein a first removal chamber is situated along a flow path of the gaseous stream between the at least one inlet and the first outlet, the first removal chamber being for removal of liquid and/or vapour from the gaseous stream, and wherein a second removal chamber is situated along a flow path of the gaseous stream between the first removal chamber and the second outlet, the second removal chamber being (downstream of the first removal chamber) for removal of contaminants from the gaseous stream.

According to another aspect described herein, there is provided a gas block for the removal of at least one contaminant from a gaseous stream from an electrolyser, comprising: at least one inlet, the at least one inlet being configured to receive a gaseous stream from an electrolyser; and at least one outlet for the release of the gaseous stream from the gas block, wherein a removal chamber is situated along a flow path of the gaseous stream between the at least one inlet and the at least one outlet, the removal chamber being for removal of at least one contaminant (preferably liquid and/or vapour and/or degraded products) from the gaseous stream. Thus, in this case the first removal and second removal chambers of the aspect described above may be combined to form a single removal chamber, with no demarcation (such as a barrier, filter, interface, or membrane) therebetween.

The gas block therefore advantageously provides a combined means for removing multiple different contaminants from a gaseous stream from an electrolyser, in contrast to existing means for purification which use separate units for different contaminants.

Preferably, the first outlet of the gas block is located in a bottom portion of the gas block such that in use liquid is removed from the gas block via the first outlet under gravity.

Preferably, the at least one inlet is located in an upper portion of the gas block.

Preferably, the gas block comprises an additional removal chamber for the recombination of hydrogen and oxygen upstream of the first outlet.

Alternatively, the gas block may comprise an additional removal chamber for the recombination of hydrogen and oxygen downstream of the first outlet.

Preferably, at least one, normally the first, removal chamber is coated with, or surface treated to have, either a hydrophobic or hydrophilic layer. Preferably, said layer is additive in the form of coatings, subtractive in the form of laser ablation, or formed by another general treatment.

Preferably, the hydrophilic or hydrophobic layer is on a substrate with a surface area up to 5000 m²/g, preferably between 1 m²/g to 5000 m²/g, more preferably between 50 m²/g and 4000 m²/g. Whilst a higher surface area may be desired, it is envisaged that a surface area between 1 m²/g to 10 m²/g may also be beneficial, or between 1 m²/g to 5 m²/g, or of 1 m²/g, with the optimal surface area being determined by the desired hydrophilic or hydrophobic property. Alternatively the hydrophilic or hydrophobic layer may be present on a surface with the desired effect being achieved by femtosecond laser. Such a surface may be formed on the wall itself, or on an insert placed in front of the wall. In the event an insert is desired, the first removal chamber shall be provided with means to accommodate the insertion, and removal, of a sheet insert.

In one embodiment, a coalescing filter is located in the first removal chamber. Alternatively, the coalescing filter (or other porous material) forms the boundary between the first and second chambers.

Preferably, the first removal chamber comprises a sponge like structure, or other structure for the maximisation of surface area to allow for heat exchange and/or provide nucleation sites for condensation/droplet formation.

Preferably, the sponge like structure comprises a plurality of voids, shaft voids or capillaries for the drainage of liquid. These voids, shaft voids or capillaries may be provided using any known means, such as 3D printing.

In one embodiment, the first removal chamber comprises grooves in an interior wall of the chamber.

Preferably, the second removal chamber is adapted to house a product or substance for removing degraded products from the gaseous stream.

Preferably, the second removal chamber is an amine trap comprising a product or substance for removing amines from the gaseous stream.

Preferably, the product or substance for removing amines from the gaseous stream is a cation exchange resin.

Preferably, the second removal chamber is separated from the first removal chamber by a barrier (preferably a coalescing filter or membrane), wherein the barrier has a means for allowing the gaseous stream from the first removal chamber to the second removal chamber.

Preferably, the barrier is permeable to the gaseous stream to provide the means for transferring the gaseous stream from the first removal chamber to the second removal chamber.

Preferably, the section of the barrier adjacent to the at least one inlet and/or the second outlet is impermeable to the gaseous stream.

Preferably, the gas block comprises a gas pressure regulator for regulating the pressure in the gas block and/or upstream to the electrolyser. The gas pressure regulator is preferably located on the second outlet. The regulation can be set to a pre-determined value and is preferably below 50 bar.

Preferably, the gas block further comprises a third outlet comprising a pressure release valve configured to release gas from the gas block when a threshold pressure inside the gas block is exceeded.

Preferably, the second removal chamber has a u-shaped section in the lower section of the walls.

Preferably, the second removal chamber is surrounded by the first removal chamber. It is also envisaged that flow direction may be reversed, such that the gas flows from the second chamber to the first chamber.

Preferably, the gas block is adapted to handle pressure in the range of 1 bar to 1000 bar, more preferably 2 bar to 100 bar, and more preferably still between 20 bar and 50 bar.

Preferably, active cooling means are provided for some or all of the gas block.

Preferably, a heat exchanger is provided upstream of the at least one inlet. Alternatively a heat exchanger can be placed on the main body, or part of the main body, of the gas block. The main body being the outer walls of the removal chamber.

Preferably, the at least one inlet is connected to one or more electrolysers, or other electrochemical devices such as an electrochemical compressor.

Preferably, the electrolyser(s) is/are AEM electrolyser(s).

As used herein, the term ‘gas block’ is used to refer to the device containing the inlets and outlets, said inlets and outlets being apertures in fluid connection with removal zones therein for the treatment of a gaseous stream comprising hydrogen. The gas block may also be referred to as a gas manifold. The gas block can be tested, installed and swapped independently to the rest of the system it is being used with.

As used herein, the term ‘gaseous stream’ is used to refer to any stream comprising a reasonable fraction of hydrogen gas with fluid (including liquid or gaseous) contaminants such as but not limited to liquid water, water vapour, aerosols, oxygen, amines, etc.

As used herein, the term ‘liquid/vapour trap’ is also referred to as the ‘water trap’, with water being the most likely contaminant to be removed.

As used herein, the terms ‘trap’, ‘removal region’, ‘removal chamber’ and ‘removal zone’ may be used interchangeably to define the region within the gas block where the contaminant is being trapped, or the zone in which it is being removed.

As used herein, the term ‘degraded product trap’ is used interchangeably with ‘amine trap’, amine being an exemplary degradation product to be trapped.

It is envisaged that inlets will generally be in the top half of the gas block. Alternatively the inlets may be anywhere on the body of said gas block.

As used herein, the term ‘water’ may be used interchangeably with ‘liquid’ as in the preferred embodiment water is the most common liquid type present. Other embodiments such as for CO₂ electrolysis may require alcohol/water separations.

Whilst it is envisaged that there are two removal chambers, the first removal chamber for removal of liquid/vapour and the second removal chamber for the removal of amine/degraded products, it is envisaged that an additional removal chamber may be provided for the removal of contaminant gases. In the preferred embodiment wherein the gas block is coupled with an electrolyser, a notable potential contaminant is oxygen. A recombination device or catalyst layer therefore can be provided for the removal of oxygen.

Such a recombination device could take many forms such as a catalyst lined first region, or a catalytically active substrate spanning the cross section of the first removal chamber.

Alternatively, the recombination device may be upstream of, but coupled to, the gas block, or downstream. Preferably any recombination zone would be upstream of the liquid/vapour removal chamber such that the generated water may be removed in a single stage at the liquid/vapour removal chamber. However other means for water removal may be provided.

It is envisaged that the water trap (i.e. the liquid/vapour removal chamber) may be achieved with a variety of approaches, including coating the interior of the first removal chamber with a hydrophobic or hydrophilic layer. More preferably still the surface area of said removal chamber comprising a hydrophobic layer may be increased with a high surface area substrate such as carbon cloth. It is envisaged that the high surface area substrate will have a surface area of at least 5000 m²/g, or between 1 m²/g to 5000 m²/g or between 50 m²/g and 4000 m²/alternatively it may be a surface area of over 1000 m²/g or at least in the range of 500 m²/g to 5000 m²/g or in the range of 500 m²/g to 2500 m²/g. Whilst a higher surface area may be desired, it is envisaged that a surface area below 10 m²/g may also be beneficial, or below 5 m²/G, or below 1 m²/g, the surface area being determined by the desired hydrophilic or hydrophobic property. In an embodiment of the present invention there may be provided striations on an interior surface of the water trap (i.e. the first removal chamber), alternating between hydrophobically coated and/or surface treated substrate and uncoated substrate. These may be parallel or perpendicular to the flow path of the gaseous stream being processed. Other alternatives such as coalescing filters along the flow path may be used to encourage formation of droplets.

It is envisaged that the gas block may be at least partially 3D printed or otherwise manufactured such that a mesh type structure will be present in the flow path of the gaseous stream comprising hydrogen, said mesh like structure acting as a coalescing filter.

Regardless the method of manufacturing, it is envisaged that the liquid/vapour removal chamber (i.e. the first removal chamber) may comprise a coalescing filter, analogous to a sponge like structure. It is further envisaged that said sponge like structure may comprise a plurality of shaft voids in a substantially vertical orientation to allow for the drainage of liquid water to and from the liquid outlet. Other orientations encouraging liquid transfer to the liquid removal outlet are also envisaged, as are other channels such as one or more grooves on the inner wall of the liquid removal chamber to allow for the transfer of liquid.

Whilst 3D printing is not intended to be a limiting factor, as a method of manufacturing it allows for greater freedom and customisation.

In the preferred embodiment, the selected filtering option of the first stage does not degrade so that the water trap is not a limiting factor in the lifespan of the gas block.

The second removal chamber, the amine trap/degraded product trap, is envisaged to be a cation exchange resin. The first removal chamber, the water trap, upstream ensures no alkaline or otherwise potentially interfering solution such as KOH. NaOH or LiOH can reach this second trap to foul it. The geometry of the gas block also aids in this, as can be seen in the figures, with the amine trap utilising gravity as another barrier to ensure KOH does not reach the amine trap.

Whilst the amine trap resins may be regenerative, in a preferred embodiment the amine trap is sized to be able to trap all amines present in the membranes of electrolytic stacks coupled to the gas block. The amine removing substance may be any suitable substance, but is preferably a cation exchange resin, such as but not necessarily limited to Polystyrene backbone with sulfonic acid functional groups, commercially available as Dowex® G26. In certain embodiment or use cases, an additional and/or alternative anion exchange resin may be provided.

Whilst the gas block may be used in conjunction with any gaseous stream comprising hydrogen, liquid and/or gaseous contaminants, and amines, in the preferred embodiment it is coupled to an electrolyser, more preferably still and AEM electrolyser and even more preferably still and AEM electrolyser operating with a dry cathode.

It is envisaged that the present invention will function without a heat exchanger, however, in a preferred embodiment a heat exchanger may be provided between the outlet of the electrolyser or other hydrogen source, and the inlet of the gas block, on the gas block itself, such as fins or other suitable means, or a heat sink. Said heat exchanger may be a coiled pipe with ambient cooling, forced air cooling, fins radiating from said pipe to encourage cooling or any other suitable means for reducing the temperature of the stream to be treated to encourage condensation of the water or other vapours therein. The heat exchanger reduces the load of the water trap.

It is envisaged that a single gas block will be able to process the hydrogen from multiple sources either with independent inlets, or more likely a combined single inlet.

Whilst it is envisaged that the inlet and outlets are located in either the top or bottom half as described, in the preferred embodiment the inlets/outlets are configured to be in substantially the same plane at distal ends on the top or bottom of the as block, said gas block being an elongated cylinder, cuboid, or prism of any geometry. The inlets and outlets being on distal ends make use of both gravity and maximising the flow path for the gas through the removal chambers thereby maximising the amount of contaminants removed from the gaseous stream.

In one embodiment the walls of the second removal chamber are solid with only a single portion being adapted to be porous for the receipt of the gaseous stream. Such an embodiment may comprise a solid cylinder with a membrane or otherwise porous disc separating the first and second removal chambers. Means provided to separate the second (amine) removal chamber and its contents from the first (liquid/vapour) removal chamber such as a membrane, microporous layer or another carbon cloth may be used. Another example is a sintered metal with a metal membrane skin, said metal membrane having pore size of between 100 nm-200 nm with the bulk pore volume being higher at 5-10 microns. Such features can be used to provide a porous wall and base for the amine removal trap.

It is also envisaged that the wall thickness of the second removal chamber may vary. By having narrower walls and a thicker base, this allows for hydrogen to be filtered through said walls, following the path of least resistance, and allowing for water to be drawn through the thicker base and out of the gas block due to the preference of water to move form large to small pore size.

In yet another embodiment the second removal chamber (i.e. contaminant trap) has at least one or more sections of porous walls on at least part of the bottom and or sides of the amine trap. It is envisaged that the walls closest to the inlet may be solid to prevent moist gas from entering the amine trap with the walls further downstream being porous to allow for the transfer of gas from the first (liquid/vapour) removal chamber to the amine trap. It is also envisaged the section(s) of walls closest to the outlet of the amine trap may be solid to prevent the gas from bypassing the resins housed within said amine trap. In a preferred embodiment, a U-shaped section in the bottom half or bottom two thirds of the walls may be porous.

The gas block is envisaged to be able to function at a variety of pressures. Preferably, the gas block is adapted to be able to treat gaseous streams output by an electrolyser at pressure. The pressure being substantially 1 bar, or above 1 bar, in the range of 2 bar-100 bar, 10 bar to 50 bar, between 30 bar and 40 bar, or substantially 35 bar.

It is envisaged that a recombination device may be provided in the gas block, upstream of the first inlet, or downstream of the outlet. Such recombination device may comprise a catalytically active surface for the combination of hydrogen and oxygen. Such a reaction generates water, which may be removed via the first (liquid removal) outlet, hence the preferred placement upstream of said outlet.

As the gas block is envisaged as operating at elevated pressures, in the preferred embodiment a safety check valve is provided to allow the venting of the gaseous stream to prevent a potentially problematic pressure build up.

It is envisaged that the safety check valve may be pre-determined and/or amended. It is envisaged that this will be between 101% and 200% operating pressure, or 105% to 150% of the operating pressure, or more preferably, between 115% and 125% or 140% and 150%. When coupled to an AEM electrolyser it is preferably between 5 bar to 100 bar, more preferably between 20 bar and 50 bar and more preferably still between 35 bar and 45 bar. In the preferred embodiment, cooling is passive. However, it is envisaged active cooling means such as a fan may be provided.

The presently described invention has the distinct benefit of providing an all in one, compact solution for the purpose of processing hydrogen from an electrolyser prior to use, compression or storage. However, the invention may equally be used to process a gaseous stream of hydrogen other than from an electrolyser. Equally, the invention may be used to process a gaseous stream of oxygen, such as from an electrolyser, or any gaseous or multiphase effluent from an electrolyser.

The present invention is not intended to be limited by the material of construction; any suitable material may be used.

Any apparatus feature as described herein may also be provided as a method feature, and vice versa. As used herein, means plus function features may be expressed alternatively in terms of their corresponding structure.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination. It should also be appreciated that particular combinations of the various features described and defined in any aspects of the invention can be implemented and/or supplied and/or used independently.

Any feature in one aspect of the invention may be applied to other aspects of the invention, in any appropriate combination. In particular, method aspects may be applied to apparatus aspects, and vice versa. As used herein, means plus function features may be expressed alternatively in terms of their corresponding structure, such as a suitably programmed processor and associated memory.

The invention extends to methods, system and apparatus substantially as herein described and/or as illustrated with reference to the accompanying figures.

One or more aspects will now be described, by way of example only and with reference to the accompanying drawings having like-reference numerals, in which:

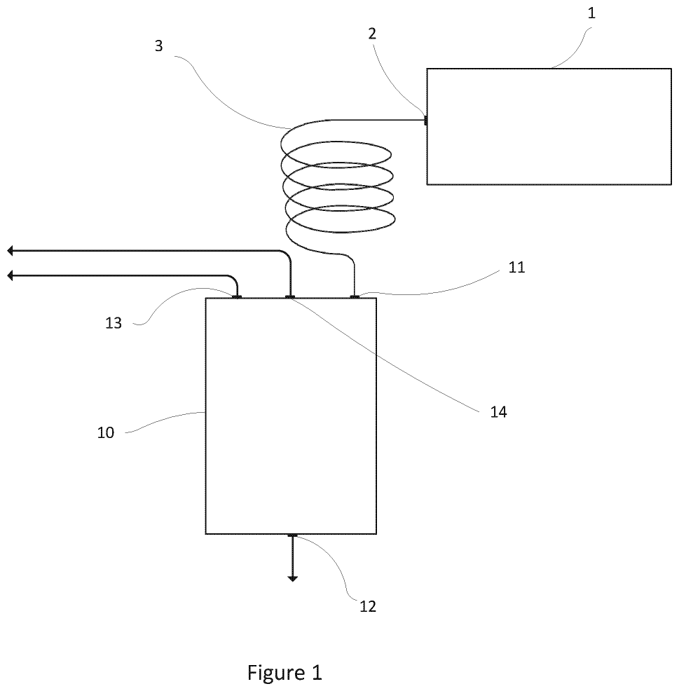

FIG. 1 is a gas block down stream of an electrolytic stack;

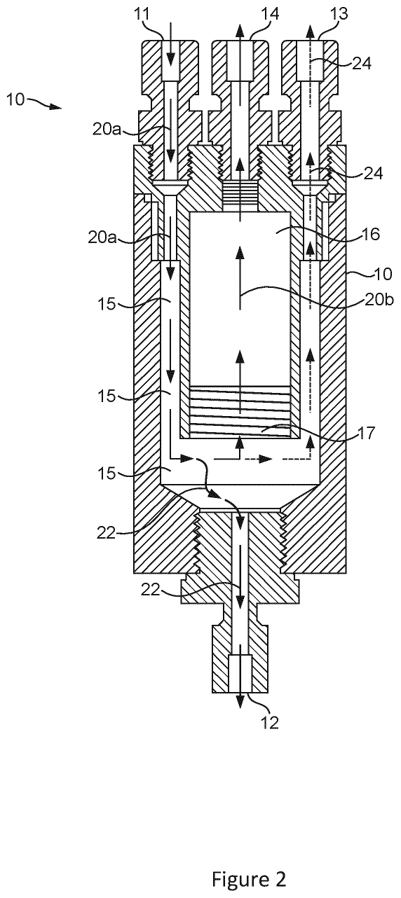

FIG. 2 is a cross section of a gas block in accordance with a first embodiment of the present invention;

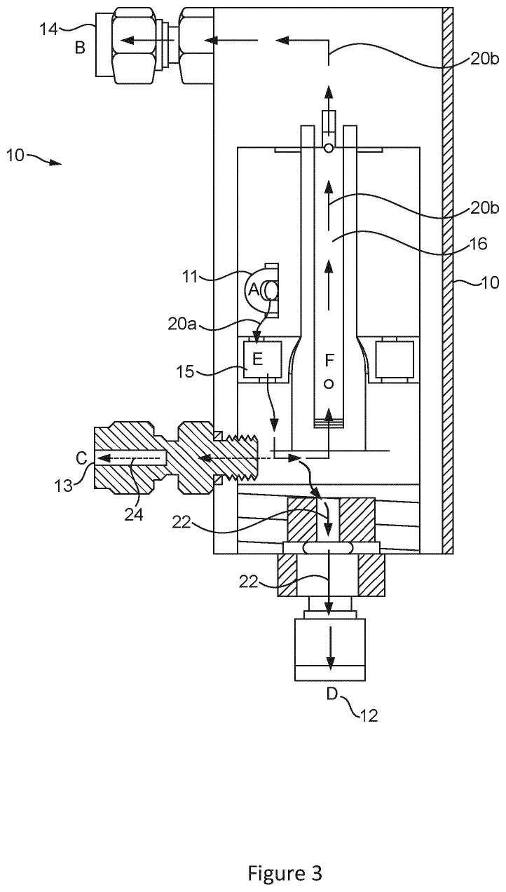

FIG. 3 is a cross section of another gas block in accordance with a second embodiment of the present invention;

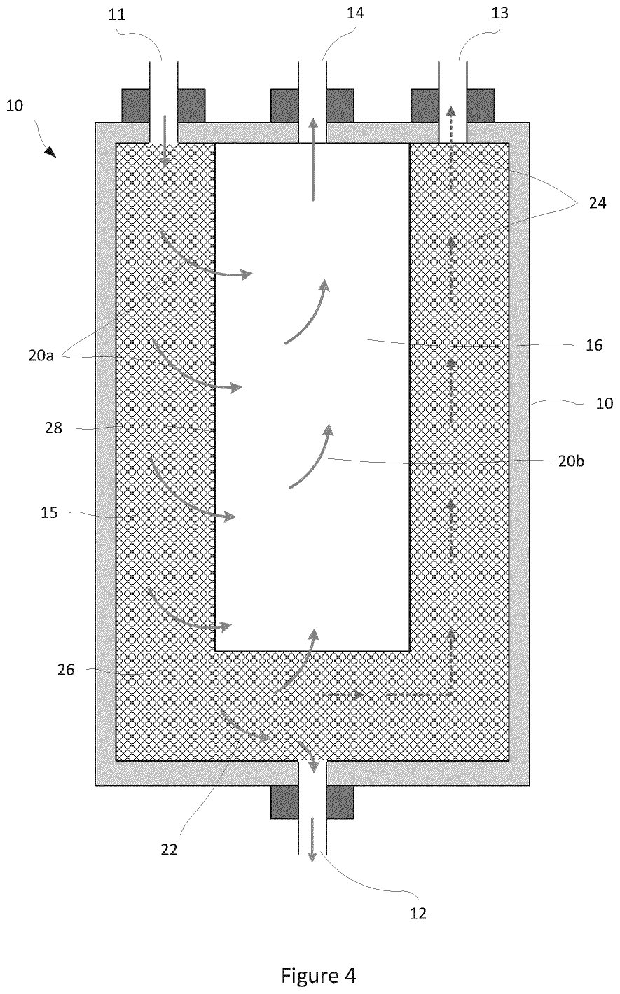

FIG. 4 is a cross section of another gas block in accordance with a third embodiment of the present invention, having a coalescing filter in the first removal chamber;

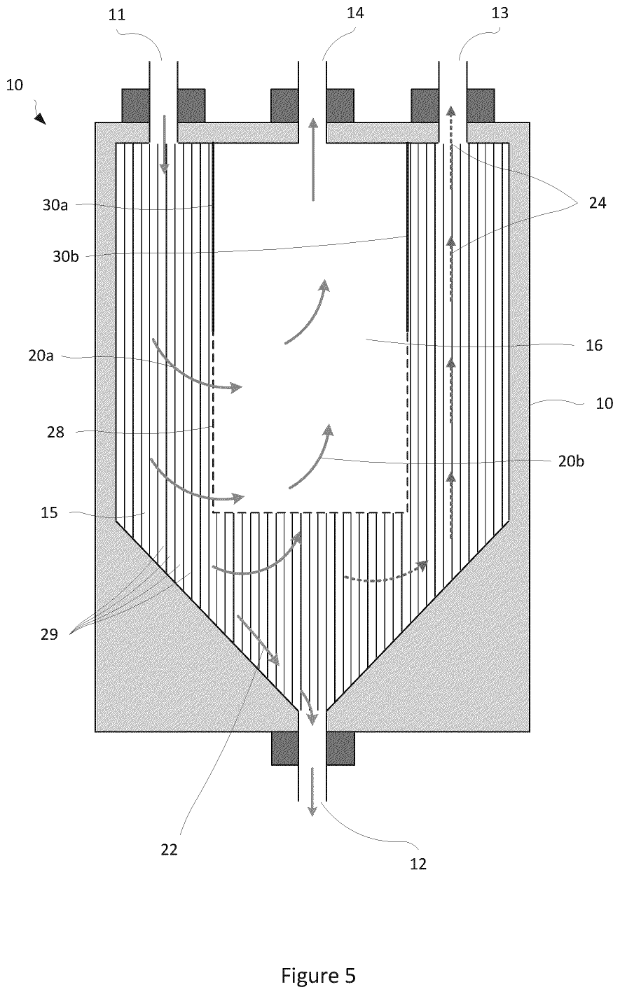

FIG. 5 is a cross section of another gas block in accordance with a fourth embodiment of the present invention, having longitudinal shafts in the first removal chamber;

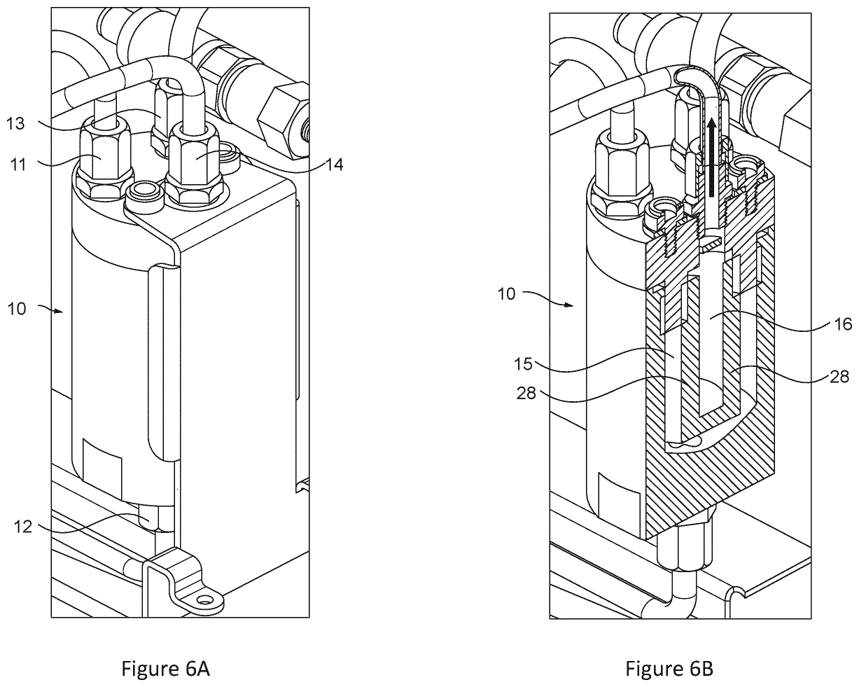

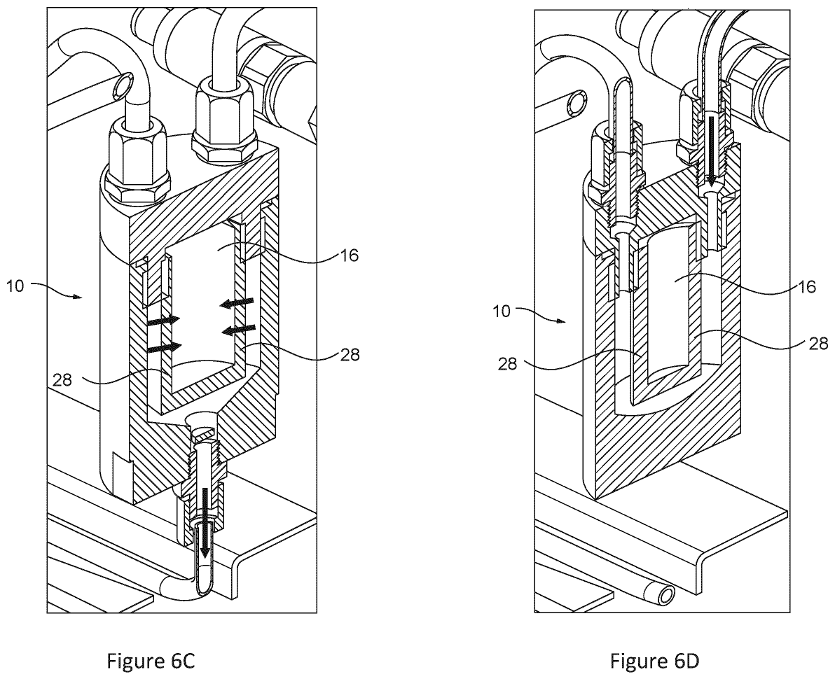

FIGS. 6A to 6D show a gas block in accordance with a fifth embodiment of the present invention; and

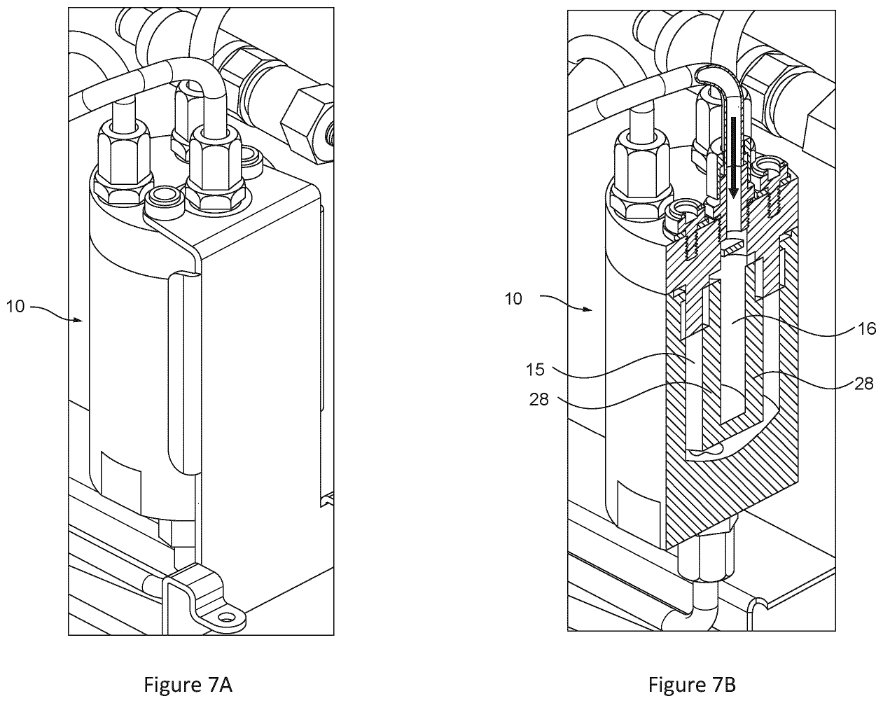

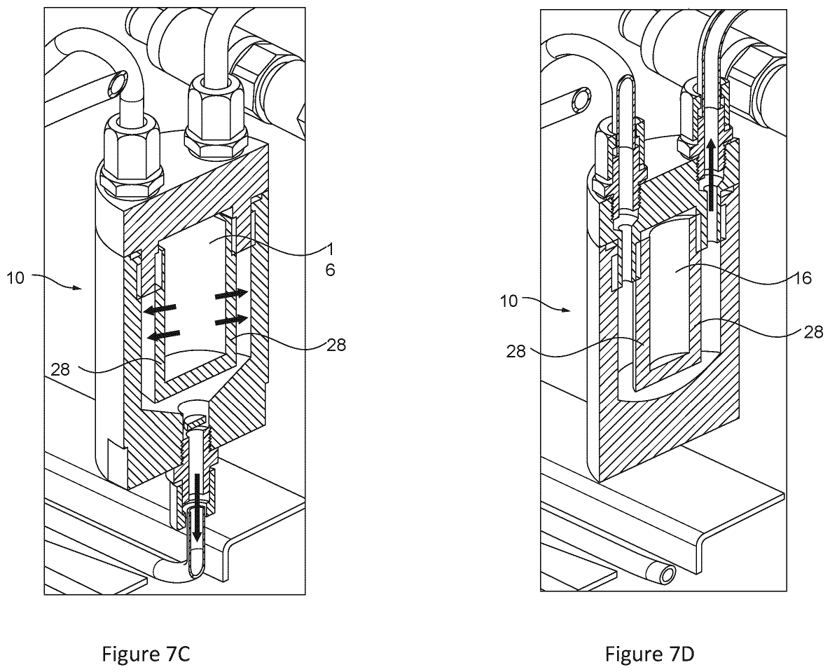

FIGS. 7A to 7D show the gas block of FIGS. 6A to 6D with a reversed flow direction.

### DETAILED DESCRIPTION

Referring to FIG. 1, there can be seen an electrolytic stack 1 with a hydrogen outlet 2. From the hydrogen outlet 2, a gaseous stream comprising predominantly hydrogen and some contaminant gases such as water vapour and amines flows to a heat exchanger coil 3, additional optional cooling means such as a fan are not shown.

The gaseous stream enters the gas block 10 via an inlet 11, as shown in FIG. 2 discussed below. From the gas block there is a liquid outlet 12, a safety check valve 13 set to release at a pre-determined pressure and an outlet 14 for the processed hydrogen. The outlet 14 being above the liquid outlet 12 but downstream of the liquid outlet, with the amine trap not shown in this figure. The inlet 11 and outlets 12, 13, 14 are adapted to be connectable to pipes for carrying fluid into the gas block (i.e. the gaseous stream from the electrolytic stack) and out of the gas block (i.e. liquid out of the liquid outlet 12 and gas out of the pressure release outlet 13 and process hydrogen outlet 14).

Referring now to FIG. 2, a cross section of the gas block 10 from FIG. 1 can be seen. From left to right on top of the gas block 10 there is the first inlet 11 for the introduction of a gaseous stream comprising hydrogen, in the middle is the hydrogen outlet 14 and on the right is the outlet to the safety check valve 13. At the bottom of the gas block 10 is the liquid/vapour outlet 12.

In use, the hydrogen containing stream enters the gas block 10 via hydrogen inlet 11 as shown by the arrows 20a indicating the flow path of the gaseous stream. The gaseous stream then flows through the first removal chamber 15. In this example, the first removal chamber 15 is a liquid/vapour removal chamber. Removal chamber 15 may be coated with hydrophobic and/or hydrophilic material, recombination catalyst or other materials. A recombination catalyst/device (not shown) may span the first removal chamber 15 to remove any oxygen present, and the liquid generated being able to leave via liquid trap 12.

As the first removal chamber 15 is a liquid/vapour removal chamber, it includes features on its interior which encourage the formation of liquid droplets so as to encourage condensation of the vapour contaminants so that they can be removed in liquid form. These features that encourage the formation of droplets may be a hydrophobic layer coating (not shown) and/or a high surface area substrate such as carbon cloth (also not shown) and/or striations on an interior surface alternating between hydrophobically coated substrate and uncoated substrate and/or surface treatments such as laser printing micron sized holes in channels or other patterns as to allow for preferential condensation, flanked by other surface treatments/coatings. These striations may be parallel or perpendicular to the direction of flow of gaseous stream being carried through the first removal chamber 15.

The liquid outlet 12 is intended to remove condensed water vapour and any contaminate KOH which has entered the gas block. By situating the outlet 12 at the bottom of the block, gravity is utilised to aid in the removal because the liquid (including vapour that has condensed in the removal chamber 15) will drain to the bottom of the block 10 and out through the outlet 12. The flow path of liquid out through the outlet 12 is indicated by arrows 22. Coalescing filters located in the first removal chamber 15 or other devices may also be used to aid in the removal of liquids.

In normal operation, the gas continues from the first removal chamber 15 to enter the second removal chamber 16. In this example, the second removal chamber 16 is an amine trap/degraded product trap for the removal of amines or other degradation products. In FIG. 2 the transition can be seen in the threaded region 17 where a mesh, membrane or other semi permeable barrier is sited to keep the amine/degraded product trapping compounds inside the second removal chamber 16. The mesh, membrane or other semi permeable barrier is located at the bottom of the second removal chamber 16 at the boundary between the second removal chamber 16 and the first removal chamber 15. The amine trap is sized such that it could theoretically handle all potential amine degradation from the attached electrochemical stack. In this example, the vertical walls separating the first removal chamber 15 from the second removal chamber 16 are impermeable to the gaseous stream, thus the stream can only enter the second removal chamber 16 after having passed through the length of the first removal chamber 15. In this way the flow path of the gas is extended through the first removal chamber 15 to encourage condensation of the vapour contaminants in the first removal chamber 15, which contaminants can be removed via the first outlet 12.

The second removal chamber (which in this example is an amine trap/degraded product trap) contains a cation exchange resin (not shown) which acts as an amine removing substance. The amine removing substance may alternatively be any suitable substance, but a cation exchange resin is preferable, such as Polystyrene backbone with sulfonic acid functional groups, commercially available as Dowex® G26.

The second outlet 14 is sited above this chamber. The gaseous stream passes through the second removal chamber 16 following the flow path indicated by arrows 20b. Gas that has been purified by passing through the first and second removal chambers is released via the second outlet 14.

The safety check valve 13 is set to automatically open, thereby venting the gas from the gas block 10, at a pre-determined threshold. The threshold is such that gas is only released if the pressure is too high for the balance of plant upstream or downstream. The flow path for gas being vented via the check valve 13 is indicated by arrows 24.

A cross section of an alternate embodiment of the present invention can be seen in FIG. 3. Hydrogen and contaminant gases enter the gas block 10 via inlet 11 (A). The stream then would pass through the liquid removal chamber 15 (E) as indicated by arrows 20a. Liquid leaves this embodiment via outlet 12 (D) as indicated by arrows 22. The gas stream continues to the amine removal chamber 16 (F) for the removal of amines and leaves, in normal use, via outlet 14 (B) as indicated by arrows 20b. The safety check valve 13 (C) is adapted to only open should the pressure surpass a pre-determined threshold; the pressure is then released by the venting of hydrogen via the valve 13 as indicated by arrows 24.

As in the previous embodiment shown in FIG. 2, the liquid removal chamber may be coated in a similar manner, and optionally house a recombination device/layer for the removal of any oxygen present. It is advantageous to locate the recombination device at the first (liquid/vapour) removal chamber, so that liquid produced as a result of any recombination can be removed via the outlet 12. If the recombination device were to be located downstream of outlet 12, an additional liquid removal outlet would be required further downstream.

FIG. 4 shows a cross sectional view of a further alternative embodiment of the present invention. In this embodiment, hydrogen and contaminant gases enter the gas block 10 via inlet 11 to enter the first removal chamber 15 (which is a liquid/vapour removal chamber). The liquid removal chamber in this embodiment contains a coalescing filter 26 indicated by the cross hatching. Specifically, first removal chamber 15 contains a mesh or sponge-like structure that acts as a coalescing filter. The mesh or sponge-like structure can be manufactured inside the first removal chamber 15 by forming the gas block 10 and mesh or sponge-like structure by 3D printing.

Vapour contaminants present in the gaseous stream entering the gas block 10 condense to form liquid in the first removal chamber 15 that is separated from the gaseous components of the stream by the coalescing filter 26. Under gravity, the liquid drains through the filter 26 to outlet 12 where it is drained as indicated by arrows 22 to remove it from the gas block.

The gas then passes from the first removal chamber 15 into the second removal chamber 16 via a hydrogen-permeable barrier layer 28 separating the two removal chambers. In this example, the second removal chamber 16 is an amine trap/degraded product trap for the removal of amines or other degradation products, thus the second removal chamber 16 contains an amine removing substance such as a cation exchange resin (not shown) which is retained within the second removal chamber 16 by the barrier layer 28. The gas continues through the second (amine) removal chamber 16 and leaves via outlet 14 as indicated by arrows 20b.

The safety check valve 13 is adapted to only open should the pressure surpass a pre-determined threshold; the pressure is then released by the venting of hydrogen via the valve 13 as indicated by arrows 24.

FIG. 5 shows a cross sectional view of a further alternative embodiment of the present invention. In this embodiment, hydrogen and contaminant gases enter the gas block 10 via inlet 11 to enter the first removal chamber 15 (which is a liquid/vapour removal chamber). The liquid removal chamber 15 in this embodiment contains a series of longitudinal shaft voids or capillaries 29 extending along the liquid removal chamber 15 in the same direction at the flow path of the gas. The capillaries 29 in this example are formed in a gas-permeable sponge-like structure. The capillaries encourage liquid to bead and condense to liquid which then drains down along the capillaries 29 to the outlet 12 through which the liquid is removed from the gas block 10. The capillaries can be manufactured inside the first removal chamber 15 by forming the gas block 10 and capillaries by 3D printing.

In this embodiment, the first removal chamber 15 and the second removal chamber 16 (which is an amine/degraded product removal chamber) are divided by a hydrogen-permeable barrier 28 along most of the perimeter of the second removal chamber 16. However, close to the hydrogen inlet 11 and the safety check valve 13, the first removal chamber 15 and second removal chamber 16 are separated by respective hydrogen-impermeable walls 30a and 30b. Hydrogen permeates across the capillaries 29 in the sponge-like material, and across the hydrogen-permeable barrier 28 into the second removal chamber 16.

Close to the hydrogen inlet 11, the impermeable wall 30a prevents any unprocessed hydrogen from entering the second (amine) removal chamber 16 almost immediately after entering the gas block 10 before the vapour contaminants would have condensed in the first (liquid) removal chamber 15. In this way, the gas is forced to flow through the first (liquid) removal chamber 15 for at least the length of the wall 30 before entering the second (amine) removal chamber 16. Similarly, the impermeable wall 30b ensures that the hydrogen enters the second removal chamber 16 at least around half-way along the second removal chamber 16, thus ensuring that the hydrogen passes through the second removal chamber 16 also for at least the length of the wall 30a before it is released via the outlet 14. The impermeable wall 30a therefore ensures a minimum level of purification of the gas in both removal chambers 15, 16.

The impermeable wall 30b close to the safety check valve 13 prevents the hydrogen in the second removal chamber 16 from being vented in the event that the valve 13 opens to relieve pressure inside the gas block. In this way, unprocessed hydrogen is vented through the valve 13 (rather than processed hydrogen) and can be redirected back to the inlet 11 for re-processing in the gas block 10.

The impermeable walls 30a and 30b are shown extended approximately halfway along the length of the second removal chamber 16, however the walls 30a, 30b could be shorter, for example extending along only a third of the length of the second removal chamber 16. Equally, the walls 30a, 30b could be longer, for example extending along the entire length of the second removal chamber 16 to leave just a portion in the bottom of the second removal chamber 16 through which gas can enter it, as in the embodiment described with reference to FIG. 1.

Vapour contaminants present in the gaseous stream entering the gas block 10 condense to form liquid in the first removal chamber 15. Under gravity, the liquid drains along the capillaries 29 to the outlet 12 where it is drained as indicated by arrows 22 to remove it from the gas block. In this example, the interior walls of the first removal chamber 15 are sloped so as to direct the liquid towards the outlet 12. The gas that passes into the second (amine) removal chamber 16 via a hydrogen-permeable barrier layer 28 passes through the amine removing substance in the second removal chamber 16 and leaves the gas block 10 via outlet 14 as indicated by arrows 20b. The safety check valve 13 is adapted to only open should the pressure surpass a pre-determined threshold; the pressure is then release by the venting of hydrogen via the valve 13 as indicated by arrows 24.

FIG. 6A to 6D shows various views and cross sections of a gas block in accordance with of a further alternative embodiment of the present invention. In this embodiment, the gas stream enters the gas block via inlet 11 and enters a first removal chamber 15 (which is a liquid/vapour removal chamber). Vapour contaminants present in the gaseous stream entering the gas block 10 condense to form liquid in the first removal chamber 15 that is separated from the gaseous components of the stream. Under gravity, the liquid drains through the filter (not shown) to outlet 12 where it is drained. The gas stream then passes from the first removal chamber 15 into the second removal chamber 16 via a hydrogen-permeable barrier layer 28 separating the two removal chambers. In this example, the second removal chamber 16 is a contaminant (e.g. a degraded products/amine) removal trap. The gas continues through the second removal chamber 16 and leaves via outlet 14. The safety check valve 13 is adapted to only open should the pressure surpass a pre-determined threshold; the pressure is then released by the venting of hydrogen via the valve 13.

FIGS. 7A to 7D show the same gas block 10 of FIGS. 6A to 6D but with a reversed flow wherein the inlet 11 and outlet 14 are reversed, with the arrows showing the fluid flow from the outlet 14 (acting as the inlet in this embodiment) into the second removal chamber 16, through the barrier 28, to the first removal chamber 15 and out of the inlet 11 (acting as the outlet in this embodiment).

Not shown in the figures is the gas pressure regulator on the hydrogen outlet which is set to a pre-determined threshold to ensure the pressure in the gas block and upstream thereof remains constant. This gas pressure regulator may be provided in the form of a valve at the inlet of the gas block (and optionally a further valve at the outlet of the gas block) calibrated to open and close at particular pressure thresholds to allow fluid into and out of the gas block.

### ALTERNATIVES AND MODIFICATIONS

It should be understood that the features disclosed in each of the embodiments of the gas block described with reference to each of FIGS. 2 to 5 can be combined. For example, at least the following modifications could be made:
The coalescing filter 26 present in the first (liquid) removal chamber 15 of the gas block of FIG. 4 could be introduced into the first removal chambers of the gas block of FIG. 2 or 3
The capillaries 29 present in the first (liquid) removal chamber 15 of the gas block of FIG. 4 could be introduced into the first removal chambers of the gas block of FIG. 2 or 3
The impermeable walls 30a, 30b and hydrogen-permeable barrier layer 28 present between the first (liquid) removal chamber 15 and the second (amine) removal chamber 16 of the gas block of FIGS. 4 and 5 could be introduced between the removal chambers of the gas block of FIG. 2, 3 or 4. In addition, the length of the impermeable walls 30a, 30b can be varied as described
The location of the various inlets (11) and outlets (12, 13, 14) of the gas block of FIGS. 2, 4 and 5 could be moved to match the locations of the respective inlets and outlets of the gas block of FIG. 2.

The invention is not intended to be restricted to the details of the above described embodiments. For instance, the material of construction may be any suitable material, and the method of construction may be any suitable method. The geometry is not necessarily intended to be a limiting factor, shown is a concentric disc and donut, there may be conical geometries in part or all of the gas block.

Additionally, the stream may comprise other contaminants not discussed to be removed elsewhere or within the gas block.

It will be understood that the invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

1. A gas block for the removal of multiple contaminants from a gaseous stream from an electrolyser, comprising:
at least one inlet, the at least one inlet being configured to receive a gaseous stream from an electrolyser; and
at least two outlets, wherein
the first outlet is configured for the removal of liquid from the gas block, and
the second outlet is configured for the release of the gaseous stream from the gas block,
wherein a first removal chamber is situated along a flow path of the gaseous stream between the at least one inlet and the first outlet, the first removal chamber being for removal of contaminant liquid and/or vapour from the gaseous stream, and
wherein a second removal chamber is situated along a flow path of the gaseous stream between the first removal chamber and the second outlet, the second removal chamber being for removal of a further contaminant from the gaseous stream.

2. A gas block as claimed in claim 1 wherein the first outlet is located in a bottom portion of the gas block such that in use liquid is removed from the gas block via the first outlet under gravity.

3. A gas block as claimed in claim 1 wherein the at least one inlet is located in an upper portion of the gas block.

4. A gas block as claimed in claim 1 with an additional removal chamber for the recombination of hydrogen and oxygen upstream of the first outlet.

5. A gas block as claimed in claim 1 with an additional removal chamber for the recombination of hydrogen and oxygen downstream of the first outlet.

6. A gas block as claimed in claim 1 wherein the first removal chamber is coated with one of: a hydrophobic layer; or a hydrophilic layer, preferably wherein the hydrophobic or hydrophilic layer is on a substrate with a surface area up to 5000 m²/g.

7. (canceled)

8. A gas block as claimed in claim 1 wherein a coalescing filter is located in the first removal chamber.

9. A gas block as claimed in claim 1 wherein the first removal chamber comprises a sponge like structure, preferably wherein the sponge like structure comprises a plurality of shaft voids for the drainage of liquid.

10. (canceled)

11. A gas block as claimed in claim 1 wherein the first removal chamber comprises grooves in an interior wall of the chamber.

12. A gas block as claimed in claim 1 wherein the further contaminant removed from the gaseous steam in the second removal chamber is a degraded product, preferably wherein the second removal chamber is adapted to house a product for removing degraded products from the gaseous stream.

13. (canceled)

14. A gas block as claimed in claim 1 wherein the second removal chamber is an amine trap comprising a product for removing amines, preferably wherein the product for removing amines is a cation exchange resin.

15. (canceled)

16. A gas block as claimed in claim 1 wherein the second removal chamber is separated from the first removal chamber by a barrier, wherein the barrier has a means for transferring of the gaseous stream from the first removal chamber to the second removal chamber, preferably wherein the barrier is permeable to the gaseous stream to provide the means for transferring the gaseous stream from the first removal chamber to the second removal chamber and/or preferably wherein the section of the barrier adjacent the at least one inlet and/or the second outlet is impermeable to the gaseous stream.

17.-18. (canceled)

19. A gas block as claimed in claim 1 further comprising a third outlet comprising a pressure release valve configured to release gas from the gas block when a threshold pressure inside the gas block is exceeded.

20. A gas block as claimed in claim 1 comprising a gas pressure regulator for regulating the pressure in the gas block and/or upstream of the gas block to the electrolyser or equivalent device, the gas pressure regulator being located on the second outlet.

21. A gas block as claimed in claim 1 wherein the second removal chamber:
has a u-shaped section in the lower section of the walls and/or is surrounded by the first removal chamber

22. (canceled)

23. A gas block as claimed in claim 1 wherein it is adapted to handle pressure in the range of 2 bar to 100 bar.

24. A gas block as claimed in claim 1 wherein active cooling means are provided for some or all of the gas block.

25. A gas block as claimed in claim 1 wherein a heat exchanger is provided upstream of the at least one inlet.

26. A gas block as claimed in claim 1 wherein the at least one inlet is connected to one or more electrolysers.

27. A gas block as claimed in claim 1 wherein the electrolyser(s) is/are AEM electrolyser(s).
